(19) United States
(12) Patent Application Publication
(10) Pub. No.: US 2013/0331151 A1
(43) Pub. Date: Dec. 12, 2013

(54) COMMUNICATION TERMINAL, PROCESSOR, AND TRANSMISSION CONTROL METHOD

(71) Applicants: FUJITSU LIMITED, Kawasaki-shi (JP); NTT DOCOMO, INC., Tokyo (JP)

(72) Inventors: Hirotoshi SHIMIZU, Yokohama (JP); Satoru Kohiyama, Kawasaki (JP); Takasi Saitou, Yokosuka (JP); Ichitaro Tsukada, Chiyoda (JP)

(73) Assignees: NTT DOCOMO, INC., Tokyo (JP); FUJITSU LIMITED, Kawasaki-shi (JP)

(21) Appl. No.: 13/870,581

(22) Filed: Apr. 25, 2013

(30) Foreign Application Priority Data
Jun. 6, 2012 (JP) 2012-129071

(51) Int. Cl. H04W 52/02

(52) U.S. Cl. CPC H04W 52/0209
USPC 455/566; 455/574

(57) ABSTRACT

In a communication terminal, a communication occurrence notifying unit detects occurrence of data communication. A determining unit determines whether the data communication occurs and whether an SCRI is transmitted based on a time set in a timer. A transmitting unit transits the SCRI to a network according to the determination result of the determining unit. The determining unit determines whether the SCRI is transmitted based on an expiration time of “N×S” seconds longer than “N×P” seconds, after the SCRI is transmitted in accordance with expiration of “N×P” seconds.

### CROSS-REFERENCE TO RELATED APPLICATION

This application is based upon and claims the benefit of priority of the prior Japanese Patent Application No. 2012-129071, filed on Jun. 6, 2012, the entire contents of which are incorporated herein by reference.

### FIELD

The embodiments discussed herein are related to a communication terminal, a processor, and a transmission control method.

### BACKGROUND

In recent years, smartphones have been popularized as communication terminals (hereinafter, also simply referred to as “terminals”) capable of performing data communication. A plurality of applications (hereinafter, also simply referred to as apps) can be installed in the smartphones. The apps operating in the smartphones are generally assumed to be normally connected to networks. Accordingly, since a plurality of apps are normally connected to networks in the smartphones, power consumption is large and battery decrease is fast, compared to conventional portable telephones.

Accordingly, with the advent of smartphones, a fast dormancy function used to reduce power consumption of a terminal has been popularized.

The fast dormancy function refers to a function of suppressing the amount of power consumption of a terminal by transitioning from an active state of the terminal to a power-saving (battery efficient) state of the terminal, when a data session is paused between the terminal and a network. The power-saving state is also referred to as a dormancy state. Further, the power-saving state includes connection states such as an idol state, Cell_PCH, URA_PCH, and Cell_FACH.

A terminal having the fast dormancy function transmits a request signal used to give a request to transition to a power-saving state to a network, when data communication by an app ends. The request signal is referred to as an SCRI (Signaling Connection Release Indication) in Release 8 of 3GPP.

Related-art examples are described, for example, in Japanese Laid-open Patent Publication No. 2011-228805 and Japanese Laid-open Patent Publication No. 2005-033481.

Even when a display of a terminal is extinct, that is, a display of a terminal is turned off, there is an app (hereinafter, also referred to as an “intermittent communication app”) intermittently performing data communication. When an intermittent communication app is installed in a terminal, the terminal transmits an SCRI at the time of ending data communication, a signal traffic may increase, and a network load may thus increase.

Accordingly, to suppress the increase in the signal traffic, a technology for transmitting the SCRI initially when data communication does not occur within a predetermined time after the end of the data communication can be considered, instead of the immediate transmission of the SCRI after the end of the data communication. According to this technology, a timer in which a predetermined expiration time is set is used. When data communication occurs, the timer is reactivated. When the timer expires, the SCRI is transmitted. That is, according to this technology, it is possible to suppress the increase in the signal traffic by not transmitting the SCRI while there is a possibility of the data communication occurring.

Here, to suppress the increase in the signal traffic, an expiration time of the timer may be set as long as possible. On one hand, to reduce the power consumption of a terminal, the expiration time of a timer may be set as short as possible. That is, as the expiration time of the timer is set longer, an effect of suppressing the increase in the signal traffic can be improved. However, an effect of reducing the power consumption of the terminal may be lowered. On the other hand, as the expiration time of the timer is set shorter, the effect of reducing the power consumption of the terminal can be improved. However, the effect of suppressing the increase in the signal traffic may be lowered.

### SUMMARY

According to an aspect of an embodiment, a communication terminal includes a transmitting unit that transmits a request signal to make a request for transition to a power-saving state, a timer that has a first time and a second time longer than the first time as expiration times, and a determining unit that performs a determining process of determining whether the request signal is transmitted based on the second time, after the request signal is transmitted in accordance with expiration of the first time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of a terminal according to a first embodiment;

FIG. 2 is a diagram illustrating state transition of a process of the terminal according to the first embodiment;

FIG. 3 is a flowchart illustrating the process of the terminal according to the first embodiment;

FIG. 4 is a functional block diagram illustrating an example of a terminal according to a second embodiment;

FIG. 5 is a diagram illustrating state transition of a process of the terminal according to the second embodiment;

FIG. 6 is a diagram illustrating a process of a terminal according to a third embodiment; and

FIG. 7 is a diagram illustrating an example of a hardware configuration of a terminal.

### DESCRIPTION OF EMBODIMENTS

Preferred embodiments of the present invention will be explained with reference to accompanying drawings. The present disclosure is not limited to the embodiments of the terminal, the processor, and the transmission control method to be described below. The same reference numerals are given to constituent elements having the same functions in each embodiment, and the description thereof will not be repeated.

### [a] First Embodiment

Configuration of Terminal

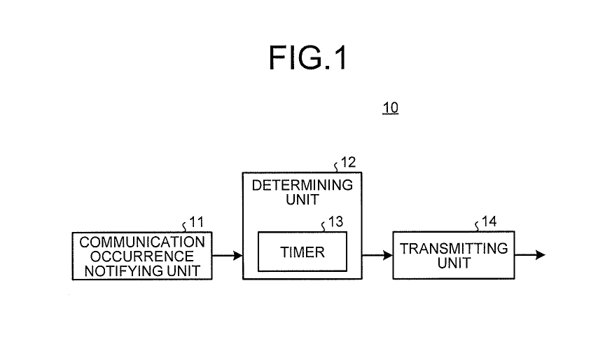

FIG. 1 is a functional block diagram illustrating an example of a terminal according to a first embodiment. In FIG. 1, a terminal 10 includes a communication occurrence notifying unit 11, a determining unit 12, a timer 13, and a transmitting unit 14.

The communication occurrence notifying unit 11 detects occurrence of data communication. When data communication occurs by one app among a plurality of apps installed in the terminal 10, the communication occurrence notifying unit 11 outputs a notification indicating the occurrence of the data communication to the determining unit 12.

The determining unit 12 determines whether the data communication occurs and an SCRI is transmitted based on a time set in the timer 13. When the determining unit 12 determines that the SCRI is “transmitted,” the determining unit 12 outputs an instruction to transmit the SCRI to the transmitting unit 14. This determination will be described below in detail.

The transmitting unit 14 transmits the SCRI to a network, when the instruction to transmit the SCRI is input from the determining unit 12.

Process of Terminal

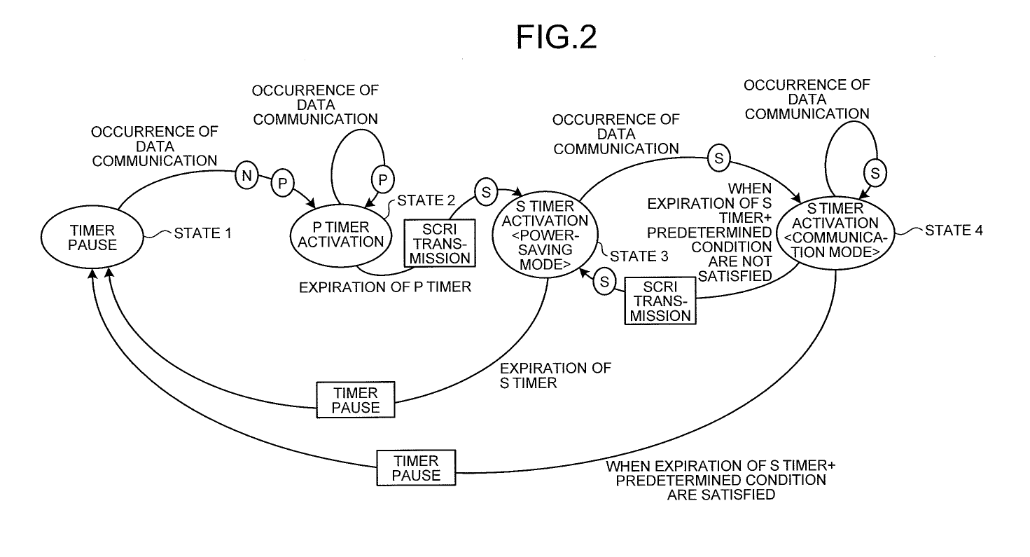

FIG. 2 is a diagram illustrating state transition of a process of the terminal according to the first embodiment.

As illustrated in FIG. 2, the terminal 10 enters one state of states 1 to 4. In FIG. 2, “N” indicates behavior of a periodic timer. “P” indicates counter setting of a P (Primary) timer. “S” indicates counter setting of an S (Secondary) timer.

Here, the timer 13 functions as the P timer and the S timer. That is, an expiration time of the timer 13 is defined as “N seconds×P times” and “N seconds×S times” and the determining unit 12 sets counter values of P times and S times in the timer 13. The N seconds are a time of a periodic timer and are a constant time. Further, “P times<S times” is satisfied. For example, “N=2 seconds,” “P=2 to 5 times,” and “S=16 to 19 times” are preferably set. In this case, the expiration time of the P timer is 4 seconds to 10 seconds and the expiration time of the S timer is 32 seconds to 38 seconds. Thus, the timer 13 functions as two kinds of timers with different expiration times according to the setting by the determining unit 12.

Setting the counter value of P times in the timer 13 is the same as setting “N×P” seconds in the timer 13. Likewise, setting the counter value of S times in the timer 13 is the same as setting “N×S” seconds in the timer 13. That is, the timer 13 is a timer in which “N×S” seconds longer than “N×P” seconds and “N×P” seconds can be set as the expiration time.

When data communication occurs in a pause state (state 1) of the timer illustrated in FIG. 2, the determining unit 12 activates the periodic timer and sets the counter value of P times in the timer 13. Thus, the timer 13 enters an activation state as the P timer having the expiration time of “N×P” seconds (state 2).

When data communication occurs in the P timer activation state (state 2), the determining unit 12 determines that the SCRI is “not transmitted” and resets the counter value of P times in the timer 13. Thus, the P timer is reset and reactivated (state 2).

While the “N×P” seconds do not expire in the P timer activation state (state 2), the determining unit 12 determines that there is a possibility of occurrence of subsequent data communication and determines that the SCRI is “not transmitted.”

On the other hand, when “N×P” seconds expire in the P timer activation state (state 2) (expiration of the P timer), that is, the data communication does not occur during elapse of “N×P” seconds from the occurrence of the immediately previous data communication, the determining unit 12 determines that the SCRI is “transmitted.” Accordingly, the determining unit 12 outputs the instruction to transmit the SCRI to the transmitting unit 14. Thus, the transmitting unit 14 transmits the SCRI to the network. Accordingly, the terminal 10 transitions to the power-saving state. Then, the determining unit 12 sets the counter value of S times in the timer 13. Thus, the timer 13 enters the activation state as the S timer having the expiration time of “N×S” seconds (state 3). The state 3 is an S timer activation state of the power-saving mode.

When the data communication occurs in the S timer activation state <power-saving mode> (state 3), the determining unit 12 determines that the SCRI is “not transmitted” and resets the counter value of S times in the timer 13. Thus, the timer 13 is reset and is reactivated as the S timer (state 4). The state 4 is the S timer activation state of the communication mode.

On the other hand, when “N×S” seconds expire in the S timer activation state <power-saving mode> (state 3) (expiration of the S timer), that is, the data communication does not occur during elapse of “N×S” seconds from the transmission of the immediately previous SCRI, the determining unit 12 determines that the data communication does not occur anymore and pauses the timer 13 by stopping the periodic timer. Thus, the state is returned from the state 3 to the state 1. At this time, since the terminal 10 already transitions to the power-saving state, the determining unit 12 determines that the SCRI is “not transmitted.”

When the data communication occurs in the S timer activation state <communication mode> (state 4), the determining unit 12 determines that the SCRI is “not transmitted” and resets the counter value of S times in the timer 13. Thus, the S timer is reset and reactivated (state 4).

While “N×S” seconds do not expire in the S timer activation state <communication mode> (state 4), the determining unit 12 determines that there is a possibility of occurrence of the subsequent data communication and determines that the SCRI is “not transmitted.”

On the other hand, when “N×S” seconds expire in the S timer activation state <communication mode> (state 4) (expiration of the S timer), that is, the data communication does not occur during elapse of “N×S” seconds from the occurrence of the immediately previous data communication, the determining unit 12 determines whether the SCRI is transmitted depending on whether a predetermined condition is satisfied.

That is, when “N×S” seconds expire in the S timer activation state <communication mode> (state 4) (expiration of the S timer), and the predetermined condition is not satisfied, the determining unit 12 determines that the terminal 10 does not transition to the power-saving state and determines that the SCRI is “transmitted.” Accordingly, the determining unit 12 outputs an instruction to transmit the SCRI to the transmitting unit 14. Thus, the transmitting unit 14 transmits the SCRI to the network. Accordingly, the terminal 10 transitions to the power-saving state. Further, the determining unit 12 resets the counter value of S times in the timer 13. Thus, the S timer is rest and reactivated, and the state is returned from the state 4 to the state 3.

On the other hand, when “N×S” seconds expire in the S timer activation state <communication mode> (state 4) (expiration of the S timer), and the predetermined condition is satisfied, the determining unit 12 determines that the SCRI is “not transmitted.” Then, the determining unit 12 pauses the timer 13 by stopping the periodic timer. Thus, the state is returned from the state 4 to the state 1.

Here, the following condition can be set specifically as the predetermined condition.

<Condition 1> is a condition in which the data communication does not occur within a predetermined time from the occurrence of the immediately previous data communication. Here, the predetermined time is a time longer than “N×S” seconds. Further, as the predetermined time, a time in which the terminal 10 forcibly transitions to the power-saving state by a request from a network side is preferably set as a reference. For example, the predetermined time is preferably set to 120 seconds. This is because there is a possibility that the terminal 10 already transitions to the power-saving state by the request from the network side when the data communication does not occur within the predetermined time from the occurrence of the immediately previous data communication.

<Condition 2> is a condition in which the number of times that the data communication occurs from the initial activation of the S timer in the communication mode is equal to or greater than a predetermined number of times. This is because the state of the terminal 10 is prevented from staying in the state 4 for a long time and the power of the terminal 10 is prevented from being excessively consumed.

As the predetermined condition, one of <Condition 1> or <Condition 2> may be set or both of <Condition 1> or <Condition 2> may be set.

As described above, the P timer is a timer provided to suppress the power consumption of the terminal 10 by transmitting the SCRI to the terminal 10 rapidly and causing the terminal 10 to transition to the power-saving state rapidly. On the other hand, the S timer is a timer provided to suppress the increase in the signal traffic by causing the terminal 10 to maintain the data communication state and not transmitting the SCRI as far as possible. Thus, by using two kinds of timers for different purposes, the transmission frequency of the SCRI can be set to be different for a plurality of apps performing data communication intermittently at different intervals.

That is, in regard to an app performing the data communication intermittently at a long period of intervals of about several tens of minutes, the terminal 10 can be caused to transition to the power-saving state rapidly by the P timer. On the other hand, in regard to an app performing the data communication intermittently at a short period of intervals of about several seconds to several tens of seconds, the data communication state can be maintained as far as possible by the S timer. Thus, in the terminal 10 in which the plurality of apps performing the data communication intermittently at different intervals are installed, it is possible to cause reduction in the power consumption and reduction in the number of transmissions of the SCRI to be compatible.

Process of Terminal

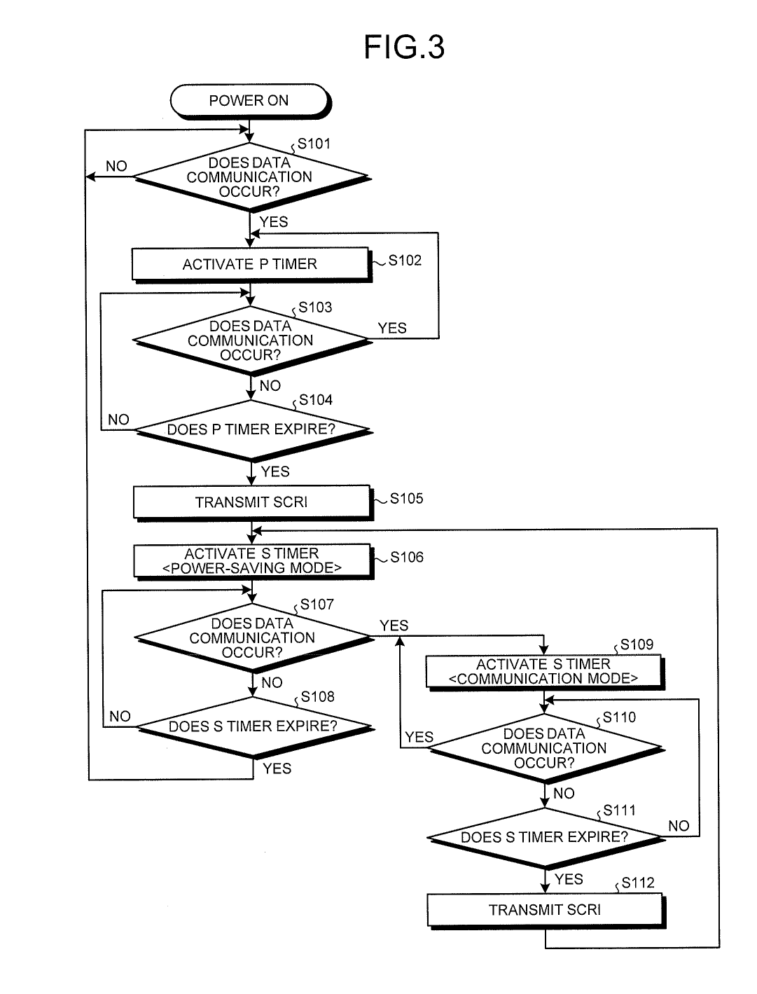

FIG. 3 is a flowchart illustrating the process of the terminal according to the first embodiment.

When the terminal 10 is turned on, the terminal 10 enters a standby state in which the occurrence of the data communication waits (No in step S101). When the data communication occurs (Yes in step S101), the P timer is activated (step S102).

During the activation of the P timer, the occurrence of the data communication is detected (step S103).

When the data communication occurs until the expiration of the P timer (No in step S104 and Yes in step S103), the P timer is reset and reactivated (step S102).

On the other hand, when the P timer is activated and the data communication does not occur (No in step S103) and the P timer expires (Yes in step S104), the SCRI is transmitted (step S105) and the S timer in the power-saving mode is activated (step S106).

During the activation of the S timer in the power-saving mode, the occurrence of the data communication is detected (step S107).

When the data communication occurs until expiration of the S timer in the power-saving mode (No in step S108 and Yes in step S107), the S timer is reset and is reactivated as the S timer in the communication mode (step S109).

On the other hand, when the S timer in the power-saving mode is activated and the data communication does not occur (No in step S107) and the S timer expires (Yes in step S108), the process returns to step S101.

During the activation of the S timer in the communication mode, the occurrence of the data communication is detected (step S110).

When the data communication occurs until the expiration of the S timer in the communication mode (No in step S111 and Yes in step S110), the S timer in the communication mode is reset and reactivated (step S109).

On the other hand, when the S timer in the communication mode is activated and the data communication does not occur (No in step S110) and the S timer expires (Yes in step S111), the SCRI is transmitted (step S112) and the S timer is reset and reactivated as the S timer in the power-saving mode (step S106).

In the first embodiment, as described above, the terminal 10 includes the timer 13 that can set “N×P” seconds and “N×S” seconds (where, P<S) as the expiration time. Further, the determining unit 12 of the terminal 10 determines whether the SCRI is transmitted based on the expiration time of “N×S” seconds longer than “N×P” seconds, after “N×P” seconds expire and the SCRI is thus transmitted. The transmitting unit 14 transmits the SCRI depending on the determination result of the determining unit 12. Thus, it is possible to suppress the increase in the signal traffic while suppressing the power consumption of the terminal 10.

### [b] Second Embodiment

Configuration of Terminal

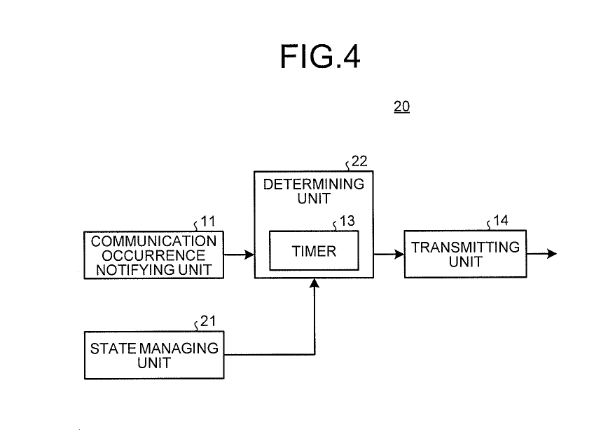

FIG. 4 is a functional block diagram illustrating an example of a terminal according to a second embodiment. In FIG. 4, a terminal 20 includes a communication occurrence notifying unit 11, a state managing unit 21, a determining unit 22, a timer 13, and a transmitting unit 14.

Depending on the setting of a network side, it can be assumed that the terminal 20 already transitions to the power-saving state when the timer 13 expires. The terminal 20 transitions to the power-waving state, for example, when a time in which the terminal 20 is forcibly caused to transition to the power-saving state by a request from the network side is shorter than “N×P” seconds or “N×S” seconds.

Thus, in the second embodiment, it is determined whether the SCRI is transmitted based on whether the terminal 20 is already in the power-saving state as described below.

That is, the state managing unit 21 manages the state of the terminal 20 and notifies the determining unit 22 of the state of the terminal 20. In particular, the state managing unit 21 manages whether the terminal 20 is in the power-saving state.

The determining unit 22 determines whether the SCRI is transmitted based on whether the data communication occurs, the time set in the timer 13, and whether the terminal 20 is in the power-saving state.

Process of Terminal

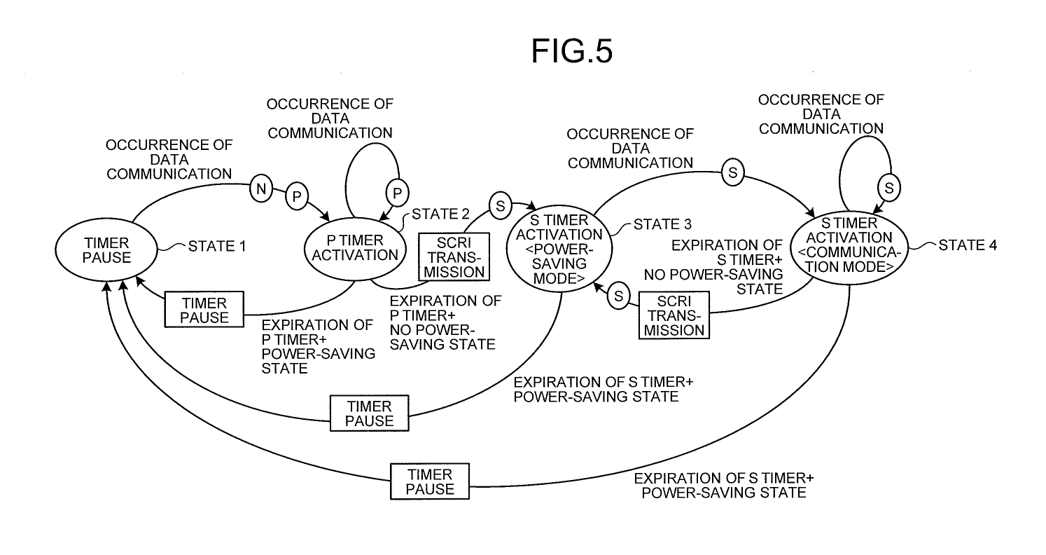

FIG. 5 is a diagram illustrating state transition in the process of the terminal according to the second embodiment.

As illustrated in FIG. 5, the terminal 20 enters one state of states 1 to 4, as in the first embodiment. In the second embodiment, however, a transition condition from the state 2 to the state 1, a transition condition from the state 2 to the state 3, a transition condition from the state 3 to the state 1, a transition condition from the state 4 to the state 3, and a transition condition from the state 4 to the state 1 are different from those of the first embodiment.

That is, in the second embodiment, when the P timer expires and the terminal 20 is in the power-saving state in the state 2, the state transitions from the state 2 to the state 1. When the P timer expires and the terminal 20 is not in the power-saving state in the state 2, the state transitions from the state 2 to the state 3. When the S timer expires and the terminal 20 is in the power-saving state in the state 3, the state transitions from the state 3 to the state 1. When the S timer expires and the terminal 20 is not in the power-saving state in the state 4, the state transitions from the state 4 to the state 3. When the S timer expires and the terminal 20 is in the power-saving state in the state 4, the state transitions from the state 4 to the state 1.

In the second embodiment, as described above, the determining unit 22 of the terminal 20 determines whether the SCRI is transmitted based on whether the terminal 20 is already in the power-saving state. Thus, since unnecessary transmission of the SCRI can be prevented, it is possible to control the signal traffic more appropriately.

### [c] Third Embodiment

When a plurality of terminals are synchronized, and then start and end data transmission, expiration timings of the timers 13 accord with each other between the plurality of terminals. When the expiration timings of the timers accord with each other, the transmission timings of the SCRI thus accord with each other, thereby causing an increase in a network load.

Accordingly, in a third embodiment, different expiration times are set in the plurality of terminals. Since the configuration of the terminal of the third embodiment is the same as that of the first embodiment, the description of the configuration of the terminal will not be made in the third embodiment.

Process of Terminal

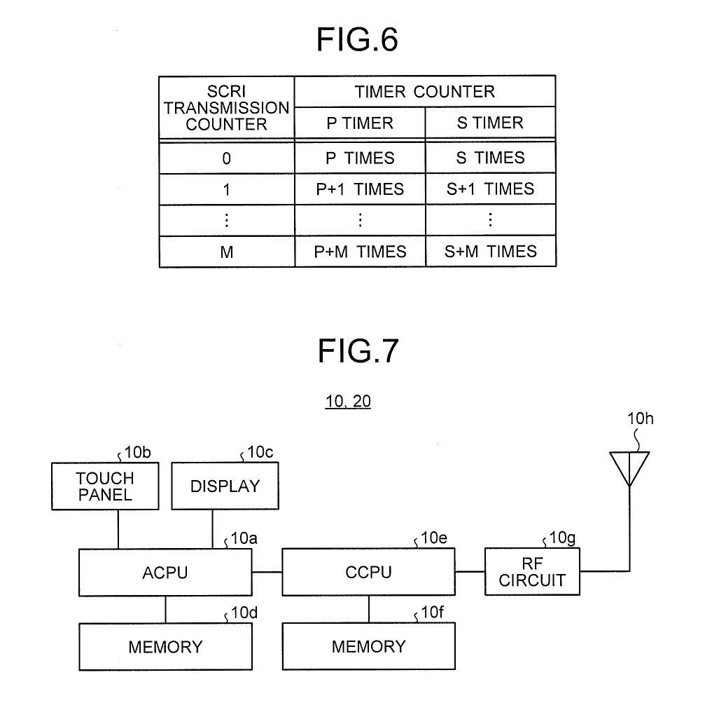

FIG. 6 is a diagram illustrating a process of a terminal according to the third embodiment.

A determining unit 12 of a terminal 10 sequentially changes an expiration time set in the timer 13 according to the number of times the SCRI is transmitted, as illustrated in FIG. 6.

Specifically, when the terminal 10 is turned on, the determining unit 12 sets 0 in an SCRI transmission counter, sets a counter value of P times in a P timer, and sets a counter value of S times in an S timer. At this time, the expiration time of the P timer is “N×P” seconds and the expiration time of the S timer is “N×S” seconds.

Then, the determining unit 12 sequentially increases the SCRI transmission counter, when the SCRI is transmitted. Accordingly, when the SCRI is transmitted M times, a counter value of P+M times is set in the P timer and a counter value of S+M times is set in the S timer. At this time, the expiration time of the P timer is “N×(P+M)” seconds and the expiration time of the S timer is “N×(S+M)” seconds.

The SCRI transmission counter returns to 0, after the SCRI transmission counter reaches M.

The determining unit 12 determines whether the SCRI is transmitted using the expiration times set in this way.

Here, timings at which the power is turned on are different between the plurality of terminals 10. Desired apps activated through user's operations in the plurality of terminals 10 are different between the terminals 10. Accordingly, while the users uses the terminals 10, the occurrence frequencies of the data communication are different between the plurality of terminals 10. Therefore, the transmission frequencies of the SCRI are also different between the plurality of terminals 10. Accordingly, by setting the expiration time of the timer 13 according to the number of times the SCRI is transmitted, different expiration times can be set in the plurality of terminals 10. By setting the expiration times of the timers 13 to be different between the plurality of terminals 10, the transmission timings of the SCRI can be dispersed.

When N is set to 2 seconds, it is preferable to set P times to two times, set “P+M” times to five times, set S times to sixteen times, and set “S+M” times to nineteen times.

In the third embodiment, as described above, the determining unit 12 of the terminal 10 determines whether the SCRI is transmitted using the different timer expiration times between the plurality of terminals 10. Thus, the transmission timings of the SCRI can be dispersed between the plurality of terminals 10. Accordingly, according to the third embodiment, it is possible to prevent the signal traffic from being centralized.

In addition, an initial value of the SCRI transmission counter set when the terminal 10 is turned on may be differently set between the plurality of terminals 10. For example, by determining the initial value of the SCRI transmission counter according to the telephone number of the terminal 10, the initial value of the SCRI transmission counter can be differently set between the plurality of terminals 10. Thus, the transmission timings of the SCRI can be further dispersed.

### [d] Other Embodiments

[1] The terminal 10 of the first and third embodiments and the terminal 20 of the second embodiment can be realized by the following hardware configuration. FIG. 7 is a diagram illustrating an example of a hardware configuration of the terminal. As illustrated in FIG. 7, the terminals 10 and 20 include an ACPU (Application Central Processing Unit) 10a, a touch panel 10b, a display 10c such as an LCD (Liquid Crystal Display), a memory 10d, a CCPU (Communication Central Processing Unit) 10e, a memory 10f, an RF (Radio Frequency) circuit 10g, and an antenna 10h as hardware constituent elements. For example, the memories 10d and 10f include a RAM such as an SDRAM, a ROM, and a flash memory. The communication occurrence notifying unit 11 and the state managing unit 21 are realized by the ACPU 10a. The transmitting unit 14 is realized by the CCPU 10e. The determining units 12 and 22 and the timer 13 are realized by the ACPU 10a or the CCPU 10e. Further, the terminals 10 and 20 may include an application processing LSI (Large Scale Integrated circuit) including the ACPU 10a and peripheral circuits. Further, the terminals 10 and 20 may include communication processing LSI including the CCPU 10e and a wireless control circuit.

[2] The various processes described above can be also realized by causing a CPU to execute a program prepared in advance. That is, programs corresponding to the respective processes performed by the communication occurrence notifying unit 11, the determining units 12 and 22, the timer 13, the transmitting unit 14, and the state managing unit 21 may be stored in advance in a memory and each program may be read by the CPU so as to function as a processor. Each program necessarily needs not to be stored in advance in the memory. That is, for example, each program may be recorded in advance in a portable recording medium such as a flexible disk (FD), a CD-ROM, an MO disk, a DVD disk, a magneto-optical disc, an IC card, or a memory card connectable to the terminals 10 and 20 and each program may be read by the CPU so as to function as a processor. For example, each program may be stored in advance in a computer, a server, or the like connected to the terminals 10 and 20 via the Internet, a LAN, a WAN, or the like in a wireless or wired way and each program may be read by the CPU so as to function as a processor.

[3] The determining unit 22 may performs a determining process according to a lighting state of the display 10c. That is, during the lighting of the display 10c, the terminal 20 is used by a user in many cases. Further, while the terminal 20 is being used by the user, there is a high possibility of data communication by an app frequently occurring. Therefore, the necessity of making the terminal 20 transitioning to the power-saving state is low. Thus, the state managing unit 21 manages the lighting state of the display 10c as the state of the terminal 20 and notifies the determining unit 22 whether the display 10c is turned on (turned on or turned off). The determining unit 22 performs the processes described in the first to third embodiments, when the display 10c is turned off. Thus, the more appropriate signal traffic control can be performed. Further, the determining unit 22 may start the processes described in the first to third embodiments after a predetermined time from a point of time at which the display 10c is turned off. Thus, it is possible to prevent the transition to the power-saving state of the terminal 20 from being delayed, even when the transmission of the SCRI is delayed since a plurality of data communication asynchronously occur immediately after the display 10c is turned off.

[4] In the first to third embodiments, the SCRI has been used as the request signal to make a request for transition to the power-saving state. However, the request signal may be a signal other than the SCRI and is not limited to its term.

[5] In the first to third embodiments, the expiration time of the timer 13 has been set by setting the number of repetitions of the periodic timer in the timer 13. However, the periodic timer necessarily needs not to be used. That is, the determining units 12 and 22 may directly set the expiration time in the timer 13 rather than setting the counter value in the timer 13.

[6] In the first to third embodiments, the case has been described in which one timer 13 functions as two kinds of timers, the P timer and the S timer. However, the terminals 10 and 20 may include a P timer as a first timer and an S timer as a second timer. That is, the terminals 10 and 20 may include two timers in which expiration times are different.

[7] In the first to third embodiments, the case has been described in the determining units 12 and 22 perform the first stage determination using the P timer and the second stage determination using the S timer, when determining whether the SCRI is transmitted. However, the stages of the determination are not limited to two stages. For example, the determination may be performed at three stages using not only the P timer and the S timer but also a timer in which an expiration time longer than the expiration time of the P timer and shorter than the expiration time of the S timer is set. Further, for example, the determination may be performed at three stages using not only the P timer and the S timer but also a timer in which an expiration time longer than the expiration time of the P timer and the expiration time of the S timer is set. That is, the determining units 12 and 22 may determine whether the SCRI is transmitted at a plurality of stages in accordance with different expiration times of a plurality of timers.

[8] The third embodiment may be combined with not only the first embodiment but also the second embodiment. Further, another embodiment [3] may be combined with not only the second embodiment but also the first and third embodiments.

According to the aspects of the present disclosure, it is possible to suppress the increase in the signal traffic, while suppressing the power consumption of the terminal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication terminal comprising:
a transmitting unit that transmits a request signal to make a request for transition to a power-saving state;
a timer that has a first time and a second time longer than the first time as expiration times; and
a determining unit that performs a determining process of determining whether the request signal is transmitted based on the second time, after the request signal is transmitted in accordance with expiration of the first time.

2. The communication terminal according to claim 1, the determining unit determines whether the request signal is transmitted based on whether the communication terminal is already in the power-saving state.

3. The communication terminal according to claim 1, the determining unit determines whether the request signal is transmitted using the first time and the second time different from each other between a plurality of communication terminals.

4. The communication terminal according to claim 1, the determining unit performs the determining process, when a display included in the communication terminal is extinct.

5. The communication terminal according to claim 4, the determining unit starts the determination process after a predetermined time passes from a point of time at which the display is extinct.

6. A processor mountable on a communication terminal transmitting a request signal to make a request for transition to a power-saving state, the processor comprising:
a timer that has a first time and a second time longer than the first time as expiration times; and
a determining unit that determines whether the request signal is transmitted based on the second time, after the request signal is transmitted in accordance with expiration of the first time.

7. A transmission control method in a communication terminal transmitting a request signal to make a request for transition to a power-saving state, the method comprising:
transmitting the request signal when a first time expires; and
determining whether the request signal is transmitted based on a second time longer the first time, after the request signal is transmitted in accordance with expiration of the first time.
